(19) United States
(12) Patent Application Publication
(10) Pub. No.: US 2015/0158125 A1
(43) Pub. Date: Jun. 11, 2015

(54) METHOD FOR PRODUCING A WELDED JOINT AND CREATING AN IMAGE OF THE WELDED JOINT BY MEANS OF COOLED X-RAY TUBES

(71) Applicant: Siemens Aktiengesellschaft, Munich (DE)

(72) Inventors: Christian Borgmann, Dorsten (DE); Michael Clossen-von Lanken Schulz, Issum (DE); Hans-Peter Lohmann, Wesel-Obrighoven (DE); Karsten Niepold, Mulheim (DE); Annett Notzel, Mulheim an der Ruhr (DE); Jurgen Stephan, Puchheim (DE)

(73) Assignee: SIEMENS AKTIENGESELLSCHAFT, Munich (DE)

(21) Appl. No.: 14/406,210

(22) PCT Filed: Jun. 11, 2013
(86) PCT No.: PCT/EP2013/061961

§ 371 Date: Dec. 6, 2014

(30) Foreign Application Priority Data
Jun. 14, 2012 (EP) 12171901.7

(51) Int. Cl. B23K 31/12; B23K 37/00; G01N 23/04; B23K 31/02

(52) U.S. Cl. CPC B23K 31/125; B23K 31/02; B23K 37/003; G01N 23/04

(57) ABSTRACT

A method for producing a welded joint is provided, including: providing an x-ray tube arranged within an x-ray housing for generating x-ray radiation and a detector arranged within a detector housing for receiving the x-ray radiation; flowing a cooling medium through the housing; heating components to be welded to the pre-heating temperature required for producing the welded joint; welding the welded joint; creating an exposure of the welded joint via the x-ray tubes and the detector at a temperature of the components which is essentially the pre-heating temperature or higher, wherein the cooling medium flows through the housing such that the x-ray tubes and the detector operate at the respective operating temperatures thereof.

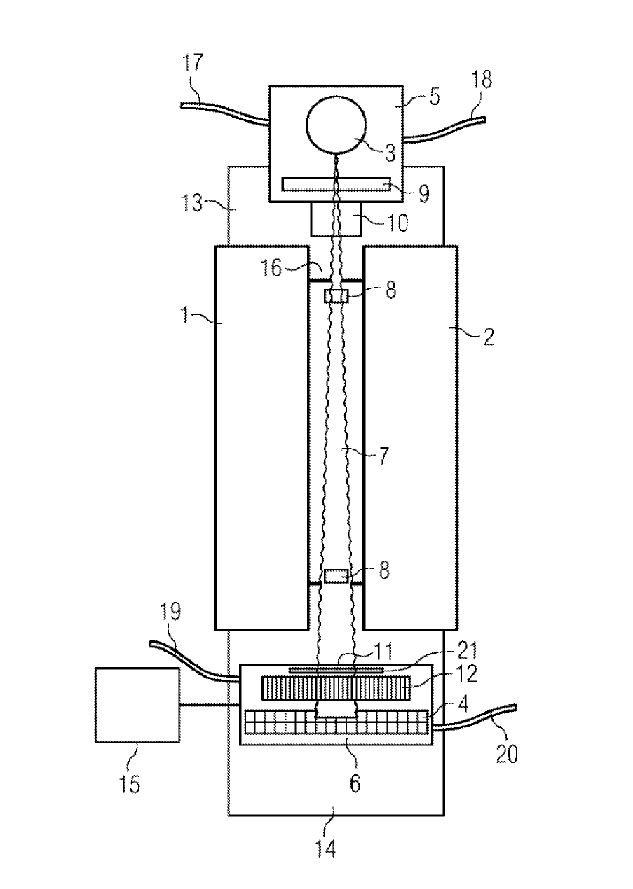

### CROSS REFERENCE TO RELATED APPLICATIONS

This application is the US National Stage of International Application No. PCT/EP2013/061961 filed Jun. 11, 2013, and claims the benefit thereof. The International Application claims the benefit of European Application No. EP12171901 filed Jun. 14, 2012. All of the applications are incorporated by reference herein in their entirety.

### FIELD OF INVENTION

The invention relates to a method for producing a welded joint.

### BACKGROUND OF INVENTION

When constructing turbomachines, welded joints have to be produced on large components. Particularly the shafts of the turbomachines are such solid and large components that various working steps are necessary for producing welded joints on the shafts. For instance, two shafts to be welded to one another have to be preheated before the welding operation, which because of the size of the shafts concerned is generally energy-intensive and time-intensive. After the welding operation, the welded joint is generally inspected for flaws, in particular with a nondestructive method of inspection. It is known to use for this an x-ray method, corresponding equipment being used to take an x-ray image of the welded joint. In order not to expose the equipment to inadmissibly high temperatures that would have the effect of the equipment being destroyed, it is required to cool the shafts down to temperatures of less than 40° C. If flaws in the welded joint are identified with the aid of the x-ray image, the welded joint must be reworked in the region of the flaws, which involves renewed preheating of the shaft.

EP 2 330 332 A2 discloses a device for inspecting and/or welding a pipe along a weld seam. This device comprises a cantilever arm, which is designed to be freely suspended and intended for inserting into the interior of a pipe to be inspected and which has a tubular main body. Furthermore, carrying means for an inspecting and/or welding device are arranged on the cantilever arm. The main body of the cantilever arm is produced substantially from a fiber-reinforced plastic.

U.S. Pat. No. 3,766,386 A discloses a device with which the thickness of steel from a rolling train is measured with the aid of x-radiation. Cooling of the detector is also provided here, in order to allow warm steel to be measured better.

US 2012 /083 346 A1 discloses a method for testing welding for connecting a shaft. For this purpose, the shaft is made up of subsections arranged symmetrically about an axis. After preparatory work, the subsections are welded together. The quality of the weld seam is checked. During the welding, the welding process can be controlled on the basis of a measured temperature.

EP 2 388 573 A2 discloses a welding arrangement and an associated method. In this case, laser-based inspections are carried out during or after the welding. Before the welding, the components to be welded are preferably preheated.

### SUMMARY OF INVENTION

An object of the invention is to provide a method for producing a welded joint that can be carried out easily and at low cost for large components.

The method according to aspects of the invention for producing a welded joint includes the following: providing an x-ray tube, arranged within a tube housing, for generating x-radiation and a detector, arranged within a detector housing, for receiving the x-radiation; making a cooling medium flow through the housings; heating components to be welded to the preheating temperature required for producing the welded joint; welding the welded joint; creating an image of the welded joint by means of the x-ray tube and the detector at a temperature of the components that is substantially the preheating temperature or higher, the housings being flowed through by the cooling medium in such a way that the x-ray tube and the detector are operated at their respective operating temperature. It is advantageously made possible by the method according to the invention that possibly occurring flaws of the welded joint on the hot components can be identified by means of the image. The flaws can be reworked immediately after they have been identified, so that there is advantageously no need for renewed preheating of the components. Consequently, both the time and the energy costs for the repeated preheating of the components can be saved.

The tube housing and/or the detector housing advantageously have channels through which the cooling medium is made to flow in such a way that the x-ray tube and/or the detector is thermally shielded from the components. Consequently, the housings act as a barrier against heat entering the x-ray tube or the detector. The tube housing and/or the detector housing are advantageously flowed through by the cooling medium in such a way that the x-ray tube and/or the detector are cooled by the cooling medium.

The tube housing advantageously has an aperture for the x-radiation, through which the cooling medium leaves the tube housing. The detector housing advantageously has an opening for the x-radiation, through which the cooling medium leaves the detector housing.

A sound damper is advantageously provided for the cooling medium flowing to and/or away from the housings. When the cooling medium flows through, it may cause an oscillation of the x-ray tube, the detector and/or the housings, which may falsify the image. The provision of the sound damper reduces the formation of the oscillation, so that images with a high accuracy can be advantageously taken.

The cooling medium may be air. The cooling medium is advantageously taken from a compressed air supply. Compressed air supplies are often already provided in technical plants, so that as a result the method can be carried out more easily. If the cooling medium is merely made to flow through the channels, water can also be used as a cooling medium, since no contact of the cooling medium with the x-ray tube and/or the detector occurs here.

### BRIEF DESCRIPTION OF THE DRAWINGS

The method according to the invention is explained below on the basis of the accompanying schematic drawing.

The FIGURE shows a section through two components to be welded, together with a device for taking an x-ray image.

### DETAILED DESCRIPTION OF INVENTION

Shown in the figure are a first component 1 and a second component 2, which are to be welded to one another. The components 1, 2 may be for example two shafts that are to be welded to one another at their end faces. Formed between the first component 1 and the second component 2 is a gap 16, in which a welded joint 8 is arranged. The welded joint 8 joins the two components 1, 2. Arranged on radially opposite sides of the components 1, 2 are an x-ray tube 3 for generating x-radiation and a detector 4 for detecting the x-radiation. An x-ray beam 7 emanates from the x-ray tube 3, spreads out in the gap 16, passes through the welded joint 8 and impinges on the detector 4.

The x-ray tube 3 is arranged in a tube housing 5 and the detector 4 is arranged in a detector housing 6. The housings 5, 6 are in this case flowed through by a cooling medium in such a way that, even in the case of hot components 1, 2, it is possible to take an x-ray image of the welded joint 8 without any damage to the x-ray tube 3 and the detector 4 being caused by an excessive temperature. For this purpose, the walls of the housing 5, 6 may incorporate channels, which run substantially parallel to the respective wall and through which the cooling medium flows in such a way that the respective wall is cooled by the cooling medium. All of the walls of the housings 5, 6 may have the cooling channels, or only some selected walls, such as for example the walls facing the components 1, 2, may have the channels. The housings 5, 6 are advantageously flowed through by the cooling medium. For this purpose, the housings 5, 6 respectively have on opposite sides a hole through which the cooling medium is made to flow into the housings 5, 6 or flow away from the housings 5, 6. It is advantageous here that the cooling medium respectively flows around the x-ray tube 3 and the detector 4. For checking the temperature, temperature sensors may be provided in the housings 5, 6, in particular directly alongside the x-ray tube 3 and/or the detector 4.

Provided on the tube housing 5 there is a feed line 17 for cooling medium flowing in and a discharge line 18 for cooling medium flowing away. Provided on the detector housing 6 there is a feed line 19 for cooling medium flowing in and a discharge line 20 for cooling medium flowing away. The feed lines 17, 19 and the discharge lines 18, 20 are arranged directly alongside the holes. Sound dampers may be provided in the lines 17 to 20 and directly alongside on the housings 5, 6. Furthermore, the lines may incorporate a control valve, for example a ballcock valve, with which the mass flow of the cooling medium can be set. Furthermore, the lines may incorporate further temperature sensors. The lines may for example be connected to a compressed air supply.

For connecting the compressed air supply, the housing may have a connection piece, which may be welded or screwed to the housing. The sound damper may be attached to the connection piece. The sound damper may also be screwed directly to the housing.

The tube housing 5 has an aperture, through which the x-radiation can leave the tube housing 5. For the case where the cooling medium flows within the tube housing, it may be provided that the cooling medium leaves into the surroundings from the aperture. In this case it is not necessary that a line for the outflowing cooling medium is provided on the tube housing 5. A bandpass filter 9 for the x-radiation is arranged within the tube housing 5, between the x-ray tube 3 and the aperture. The function of the bandpass filter is to constrict the spectral bandwidth of the x-radiation, whereby images with a high spatial resolution are advantageously possible.

The detector housing 6 has an opening in which an entry window 11 transmissive to x-radiation is fitted. It is also conceivable that no entry window 11 is provided and that, for the case where the cooling medium flows within the detector housing 6, the cooling medium leaves into the surroundings from the opening. Here it is not necessary to provide a line for the outflowing cooling medium on the detector housing 6.

Arranged between the tube housing 5 and the components 1, 2 is an x-ray lens 10, by which the divergence of the x-ray beam 7 is set. The x-ray lens 10 may also be arranged within the tube housing 5, so that it is advantageously cooled by the cooling medium. The divergence of the x-ray beam 7 is set in such a way that both the weld seam and the weld root of the welded joint 8 are irradiated. Arranged within the detector housing 6, between the entry window 11 and the detector 4, there is a stray radiation filter 12, through which the x-ray beam 7 passes. Arranged directly downstream of the x-ray tube 3 there is a first bandpass filter 9 and directly upstream of the stray radiation window 12 there is a second bandpass filter 21. For preparing the x-ray beam 7, the first bandpass filter 9, the second bandpass filter 21, the x-ray lens 10 and the stray radiation filter 12 are adjusted in relation to one another in such a way that an optimum quality of image is achieved in the detector 12.

The x-radiation is partially absorbed by the welded joint 8, whereas the transmitted x-radiation impinges on the detector. The detector 4 may be both a line-array camera and a two-dimensional image sensor. By means of an evaluation unit 15, an image is created from the transmitted x-radiation. The evaluation unit 15 is arranged outside the detector housing 6.

A first stray radiation catcher 13 is arranged around the tube housing 5 in such a way that it extends up to the components, and the wall of the tube housing that is facing the components 1, 2 is arranged within the first stray radiation catcher 13. The first stray radiation catcher 13 may also completely enclose the tube housing 5. Arranged around the detector housing 6 there is a second stray radiation catcher 14, which completely encloses the detector housing 6 and extends up to the components 1, 2. It is ensured by the stray radiation catchers 13, 14 that no x-radiation that may endanger the operating personnel escapes to the outside.

The method for producing the welded joint may be carried out by the following steps: providing the x-ray tube 3, arranged within the tube housing 5, for generating x-radiation and the detector 4, arranged within the detector housing 6, for receiving the x-radiation; making cooling air flow through the interior of the housings 5, 6, the cooling air being taken from the compressed air supply and the sound damper being respectively provided both directly alongside the housings 5, 6 and in the feed lines 17, 18; heating the components 1, 2 to be welded to the preheating temperature required for producing the welded joint 8; welding the welded joint 8; creating the image of the welded joint 8 by means of the x-ray tube 3 and the detector 4 at a temperature of the components 1, 2 that is substantially the preheating temperature or higher, the housings 5, 6 being flowed through by the cooling medium in such a way that the x-ray tube 3 and the detector 4 are operated at their respective operating temperature.

Although the invention has been illustrated more specifically and described in detail by the preferred exemplary embodiment, the invention is not restricted to the examples disclosed, and other variations may be derived therefrom by a person skilled in the art without departing from the scope of protection of the invention.

1. A method for producing a welded joint comprising:
providing an x-ray tube, arranged within a tube housing, for generating x-radiation and a detector, arranged within a detector housing, for receiving the x-radiation;
flowing a cooling medium through the housings;
heating components to be welded to the preheating temperature required for producing the welded joint;
welding the welded joint;
creating an image of the welded joint via the x-ray tube and the detector at a temperature of the components that is substantially the preheating temperature or higher, wherein the cooling medium flows through the housings such that the x-ray tube and the detector are operated at their respective operating temperature.

2. The method as claimed in claim 1,
wherein the tube housing and/or the detector housing have channels through which the cooling medium is made to flow such that the x-ray tube and/or the detector are thermally shielded from the components.

3. The method as claimed in claim 1,
wherein the cooling medium flows through the tube housing and/or the detector housing such that the x-ray tube and/or the detector are cooled by the cooling medium.

4. The method as claimed claim 1,
wherein the tube housing has an aperture for the x-radiation, through which the cooling medium leaves the tube housing.

5. The method as claimed in claim 1,
wherein the detector housing has an opening for the x-radiation, through which the cooling medium leaves the detector housing.

6. The method as claimed in claim 1,
further providing a sound damper for the cooling medium for the cooling medium flowing to and/or away from the housings.

7. The method as claimed in claim 1,
wherein the cooling medium comprises air.

8. The method as claimed in claim 7,
wherein the cooling medium is taken from a compressed air supply.
